(19) United States
(12) Patent Application Publication
(10) Pub. No.: US 2017/0002510 A1
(43) Pub. Date: Jan. 5, 2017

(54) PORTABLE WETSUIT DRYER WITH HIGH-POWER BLOWER

(71) Applicant: Thomas Blake, Santa Barbara, CA (US)

(72) Inventor: Thomas Blake, Santa Barbara, CA (US)

(21) Appl. No.: 14/790,910

(22) Filed: Jul. 2, 2015

(51) Int. Cl. D06F 59/02; F26B 21/00; F26B 9/00; A41D 13/012

(52) U.S. Cl. CPC D06F 59/02; A41D 13/012; F26B 21/008; F26B 9/003

(57) ABSTRACT

A rugged, high-power system for quickly drying a garment, such as a wet suit, that can be easily collapsed for storage or transport. The garment drying system may include a base and a vertical support member for suspending a garment above the base. The base may include a blower and one or more vent pipes for directing air from the blower into an opening of the garment. The height of the vertical support member may be adjustable to accommodate garments of various sizes. The vertical support member may be detached from the base to facilitate storage and transport. The system accommodates a high-power blower for drying a garment quickly, yet avoids the use of long or complex arrangements of air ducts to direct air throughout the garment.

### BACKGROUND

Wetsuit and other body suit dryers are known in the art. Some of these systems take the form of a small fan housed within a clothes hanger-like device that is inserted into the neck of the suit and can be hung as a typical clothes hanger. Others take the form of an arrangement of rigid air ducts that span the legs, torso, and/or arms of the suit and are connected to a blower that forces air throughout the suit via the ducts. There are a number of drawbacks associated with these systems.

### SUMMARY

It would be desirable to provide a wet suit dryer with a high airflow blower that can dry a wetsuit quickly, but also avoids long or complex arrangements of air ducts that may not only be more susceptible to damage but also require more time to assemble or disassemble for storage.

Accordingly, one aspect of the disclosure provides for a garment drying system comprising a base and a vertical support member coupled to the base and adapted to suspend a garment above the base. The base includes at least one vent that is adapted to direct air from the blower into the garment.

Another aspect of the disclosure provides a method for drying a garment. The method comprises the steps of suspending a garment from a first end of a vertical support member having a second end coupled to a base; securing an opening of at least one leg portion of the garment about a first vent pipe of said base; inserting a second vent pipe of said base into an opening of at least one boot associated with the garment; and, forcing air through said vent pipes using a blower disposed in the base.

### BRIEF DESCRIPTION OF THE DRAWINGS

FIG. 1 is a view of an exemplary garment drying system in accordance with the disclosure.

FIG. 2 is a view of an exemplary base for a garment drying system in accordance with the disclosure.

FIG. 3 is a top view of an exemplary base for a garment drying system in accordance with the disclosure.

FIG. 4 is a top view of the interior of an exemplary base for a garment drying system in accordance with the disclosure.

FIG. 5 is a side view of the interior of an exemplary base for a garment drying system in accordance with the disclosure.

FIG. 6 is a view of an exemplary garment drying system in accordance with the disclosure configured to dry two garments simultaneously.

FIG. 7 is a view of exemplary anchoring mechanisms that may be used to secure a portion of the garment about a vent pipe of a garment drying system in accordance with the disclosure.

### DETAILED DESCRIPTION

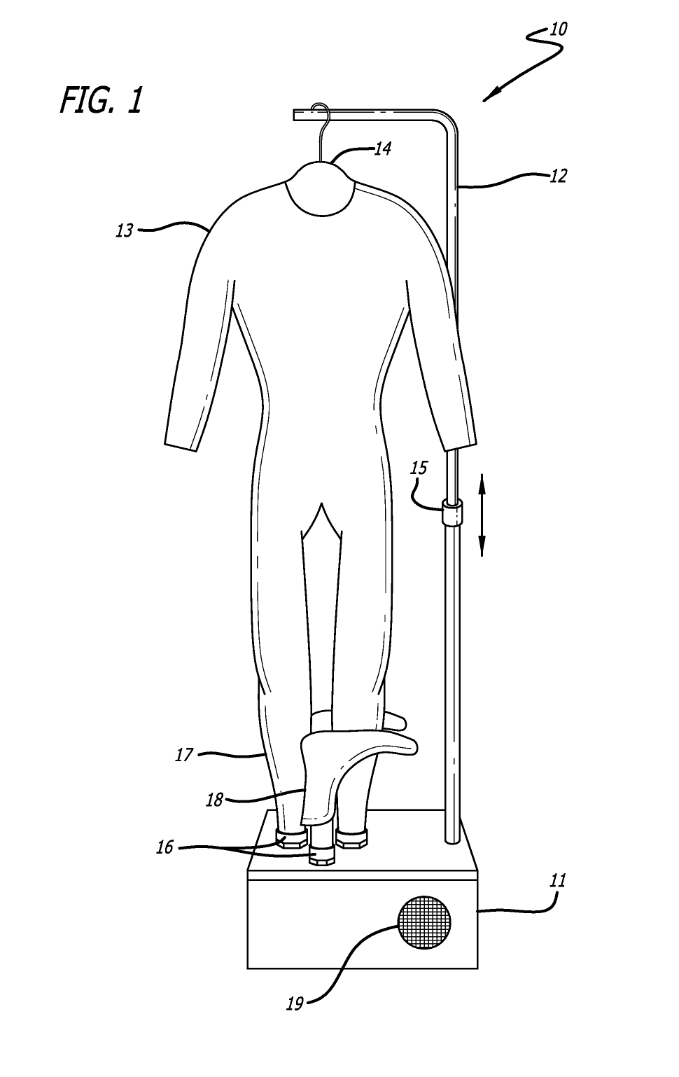

Referring to the drawings more particularly by reference numbers, FIG. 1 shows an exemplary drying system 10 in accordance with the disclosure. The garment drying system 10 may include a base 11. The base 11 may be coupled to a vertical support member 12. The vertical support member 12 may be adapted to suspend a garment 13 above the base 11. In one embodiment, the garment 13 may be suspended from the vertical support member 12 by a clothes hanger 14 inserted in a neck opening of the garment 13 and hung about the vertical support member 12. Alternatively, the garment 13 could be suspended directly from the vertical support member 12. In such an embodiment, in place of a clothes hanger 14, the vertical support member 12 may include horizontal support members (not shown) adapted to be inserted into a neck opening of the garment 13.

The base 11 may include one or more vent pipes 16. The garment 13 may include one or more leg portions 17. An opening of the at least one leg portion 17 may be secured about one of one or more vent pipes 16. The garment 13 may also include one or more boots 18, each of which may also be placed on or secured about the one or more vent pipes 16. The base 11 may house a blower (not shown) that draws air into the base 11 through an intake port 19. The intake port 19 may include a screen to prevent dust, debris, or other objects from entering the blower.

The vertical support member 12 may be constructed of any material rigid enough to support the weight of the garment, such as metal, plastic, rubber, ceramic, wood, or the like. The length of the vertical support member 12 may be adjustable to accommodate garments of varying size. In one embodiment, the vertical support member 12 may be constructed of two or more concentric sections joined by one or more compression rings 15 that can be loosened to allow the height of the vertical support member to be varied. The vertical support member 12 may be detached from the base 11 to facilitate storage and/or transport of the garment dryer system 10.

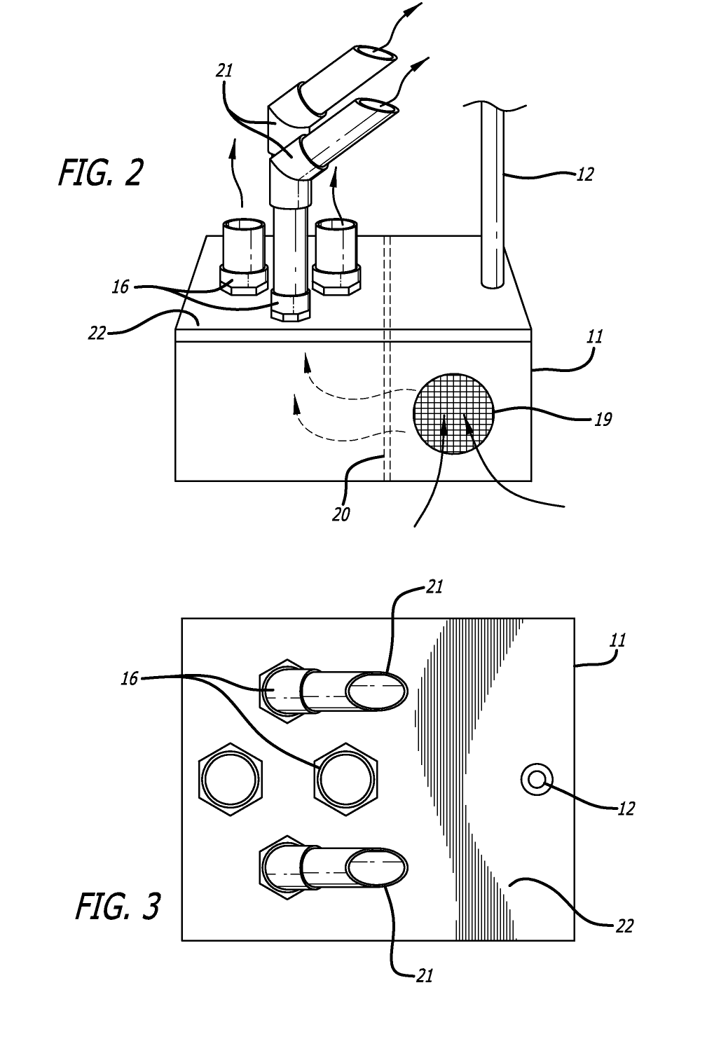

FIG. 2 illustrates a view of an exemplary base 11 of a garment dryer system in accordance with the disclosure. As discussed above, the base 11 may include a blower (not shown) that draws air into the base 11 through an intake port 19. The blower may force air from the intake port 19 through a ported baffle 20 and out through the one or more vent pipes 16. The one or more vent pipes 16 may extend upward from an upper surface 22 of base 11. Alternatively, the one or more vent pipes 16 could extend outward from any side of the base. In one embodiment, the base 11 includes four vent pipes 16. Two of the four vent pipes 16 may be inserted into the leg openings of each of a pair of leg portions of a garment. The other two of the four vent pipes 16 may include angled sections 21 that may be inserted into the openings of each of a pair of boots or shoes associated with a garment. The angled sections 21 may be sized and shaped to accommodate the internal shape and structure of a boot. Although the angled sections 21 are illustrated as being linear, they could alternatively be curved.

FIG. 3 is an overhead view of the upper surface 22 of an exemplary base 11 of a garment drying system in accordance with the disclosure. Although vertical support member 12 is shown as coupled to the base 11 within the perimeter of the upper surface 22, the vertical support member 12 could alternatively be coupled to the base 11 elsewhere, such as an exterior side of the base 11. As discussed above with respect to FIG. 2, the base may include one or more vent pipes 16 extending upward from the upper surface 22 of the base 11. In one embodiment, the base 11 includes four vent pipes 16, and two of the vent pipes 16 include angled sections 21. The vent pipes 16 without angled sections may accommodate the leg openings of the garment, while one or more boots associated with the garment may be placed about the vent pipes 16 with angled sections 21.

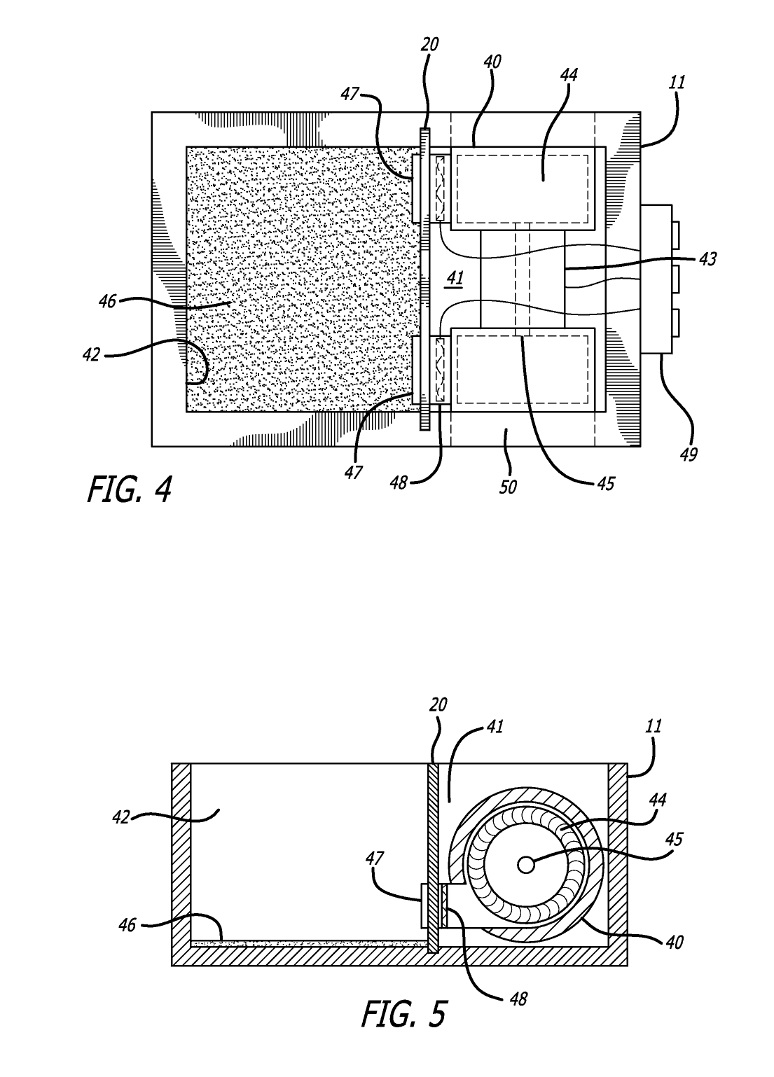

FIGS. 4 and 5 illustrate overhead and side views, respectively, of the interior of an exemplary base 11 with the top cover or upper surface removed. The base 11 may include a baffle 20 that divides the interior of the base 11 into a blower chamber 41 and a vent chamber 42. The blower chamber 41 may house a blower 40. The blower may include a motor 43 that drives one or more fans 44. In one embodiment, the motor 43 drives a pair of fans 44 joined by an axle 45. When spun by the motor 43, the one or more fans 44 draw air into the blower 40 through one or more intake ports 50, which may be cut away from the side or sides of the base 11. The blower 40 forces the air into the vent chamber 42 through one or more ports 47 in the baffle 20.

In operation, the air forced into the vent chamber 42 then exits the base 11 through one or more vent pipes (not shown). The vent chamber 42 may be lined on at least a bottom surface with an absorbent material to absorb moisture that may enter the vent chamber 42 through the vent pipes or other channels. The base 11 may also include one or more heating elements 48 for heating the air directed out the vent pipes to accelerate the drying of the garment. The blower 44, as well as the one or more heating elements 48, may be controlled using a control panel 49. The control panel 49 may take the form of a simple on/off switch. Alternatively, or additionally, the control panel 49 may provide for variable speed control of the blower 40 as well as a variable temperature control for the one or more heating elements 48. In another embodiment, the base 11 may have no switch, and instead be activated by simply coupling the base 11 to a power source, such as an AC line or battery. Although the blower 40 is illustrated as a centrifugal fan, other fan or blower configurations could be used.

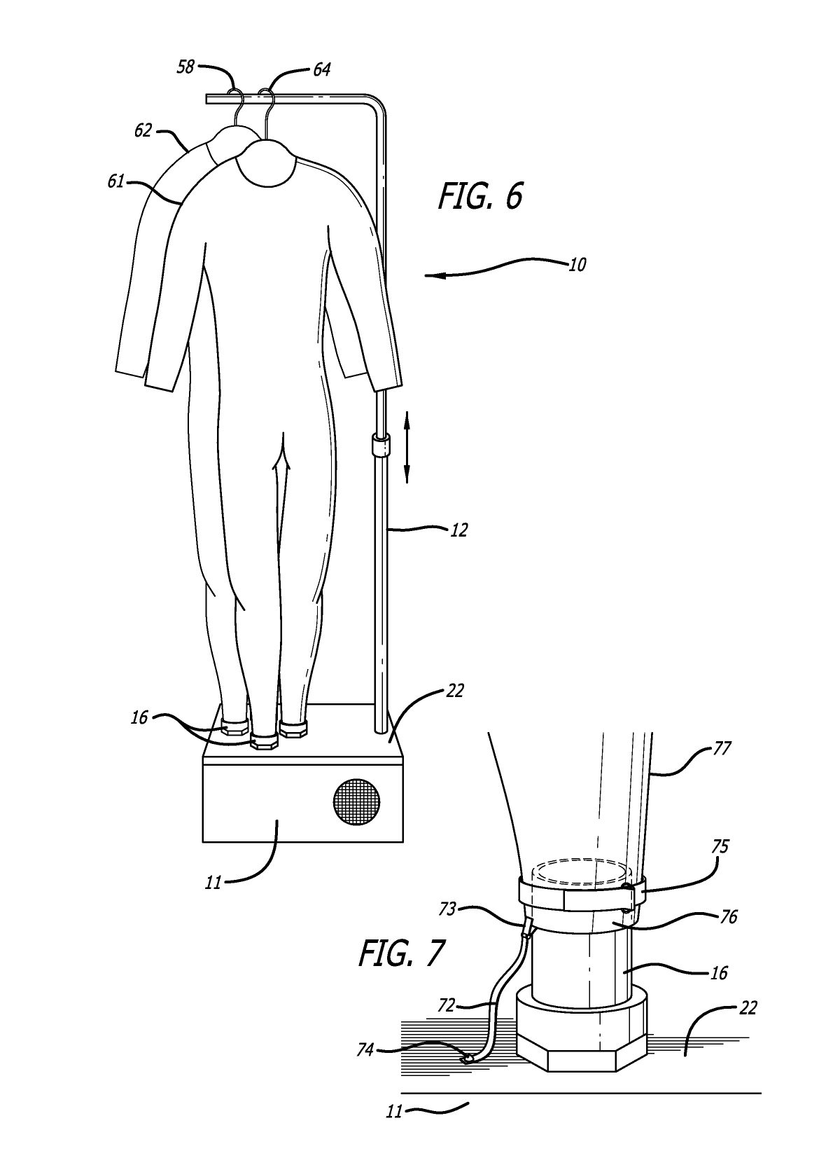

FIG. 6 illustrates another exemplary use of a garment drying system 10 in accordance with the disclosure, in which the garment drying system 10 is used to dry two garments simultaneously. In this example, two wetsuits 61, 62 are suspended from the vertical support member 12 using two clothes hangers 63, 64. An opening of each of the four leg portions of each wetsuit 61, 62 is secured about each of the vent pipes 16 extending upward from the top cover 66 of the base 11. In this embodiment, the vent pipes 16 may not include angled sections as illustrated in FIG. 2. It is to be appreciated, however, that the garment drying system 10 could include additional vent pipes, with or without angled sections, for drying more than two garments and associated boots or shoes simultaneously.

FIG. 7 illustrates exemplary anchoring mechanisms which may be used to secure the leg portion of a garment 77 about a vent pipe 16 of a garment drying system in accordance with the disclosure. In one embodiment, the anchor may take the form of a strap 72 that is attached at one end to an upper surface 22 of the base 11 with a fastener 74. The other end of the strap 72 may have a clasp 73 that can be attached to the garment 77 to prevent the garment 77 from inadvertently becoming separated from the vent pipe 71. In another embodiment, the anchor may take the form of a strap 75 that is wrapped around the garment 77 to secure it to the opening of the vent pipe 16. The strap 75 may be continuous and elastic, like a rubber band. Alternatively, the strap 75 may employ VELCRO® or a buckle for tightening the strap 75 about the garment and securing it to the opening of the vent pipe 71. It is to be appreciated that the anchoring mechanisms described above are optional and may be unnecessary if the weight and or structure of the garment is such that the garment or associated footwear remains in place about the vent pipes while the blower is running.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

I claim:

1. A garment drying system, comprising:
a base including a blower and at least one vent; and
a vertical support member coupled to the base and adapted to suspend a garment above the base, wherein the at least one vent is adapted to direct air from the blower into the garment.

2. The garment drying system of claim 1, wherein said vertical support member includes a mechanism for adjusting the length of the vertical support member.

3. The garment drying system of claim 2, wherein said mechanism includes a friction joint.

4. The garment drying system of claim 1, wherein said base includes a first chamber and a second chamber.

5. The garment drying system of claim 4, wherein said first and second chambers are separated by a baffle having at least one port.

6. The garment drying system of claim 5, wherein said first chamber includes a blower that forces air into said second chamber through said at least one port.

7. The garment drying system of claim 6, wherein said at least one vent opens into said second chamber.

8. The garment drying system of claim 4, wherein said second chamber includes an absorbent material.

9. The garment drying system of claim 1, further including an anchor for securing said garment about said at least one vent.

10. The garment drying system of claim 1, wherein said base includes four vents.

11. The garment drying system of claim 10, wherein each of said four vents includes a pipe extending upward from an upper surface of said base.

12. The garment drying system of claim 11, wherein two of said four vent pipes include a an angled portion.

13. The garment drying system of claim 12, wherein said garment includes at least one boot, and one of said vent pipes having an angled portion is inserted into an opening of said at least one boot.

14. The garment drying system of claim 11, wherein said garment includes at least one leg portion and an opening of said at least one leg portion is secured about one of said vent pipes.

15. The garment drying system of claim 1, wherein the vertical support member has a length of at least four feet.

16. The garment drying system of claim 1, wherein the garment is one of a wetsuit and a dry suit.

17. The garment drying system of claim 1, wherein the garment is suspended from the vertical support member with a clothes hanger inserted in a neck opening of the garment.

18. A method for drying a garment, comprising:
suspending a garment from a first end of a vertical support member having a second end coupled to a base;
securing an opening of at least one leg portion of said garment about a first vent pipe extending from an upper surface of said base;
inserting a second vent pipe extending from said base into an opening of a boot associated with said garment; and,
forcing air through said vent pipes using a blower disposed in said base.

19. The method of claim 18, further comprising:
adjusting a length of said vertical support member.

20. The method of claim 18, wherein suspending said garment includes inserting a clothes hanger coupled to said vertical support member into a neck opening of said garment.
